(19) United States
(12) Patent Application Publication
(10) Pub. No.: US 2006/0066488 A1
(43) Pub. Date: Mar. 30, 2006

(54) Antenna

(76) Inventor: Ying Zhinong, Lund (SE)

Correspondence Address: MYERS BIGEL SIBLEY & SAJOVEC, PO BOX 37428, RALEIGH, NC, 27627, US

(21) Appl. No.: 10/542,310

(22) PCT Filed: Jan. 14, 2004
(86) PCT No.: PCT/EP04/00178

§ 371 Date: Jul. 15, 2005

Related U.S. Application Data
(60) Provisional application No. 60/443,365, filed on Jan. 28, 2003.

(30) Foreign Application Priority Data
Jan. 17, 2003 (EP) 03001011.0

(51) Int. Cl. H01Q 1/24

(52) U.S. Cl. 343/702

(57) ABSTRACT

An antenna arrangement for a portable communication device, and portable communication device including such an antenna arrangement are described. The antenna arrangement includes antenna patches that are configured to be connected to respective feeding potentials and include a variable capacitance feeding. The antenna patches are separated by a gap and have lengths approximately equal to each other.

### TECHNICAL FIELD OF THE INVENTION

The present invention relates to the field of antennas and more particularly to an antenna arrangement for a portable communication device as well as a portable communication device including such an antenna arrangement built-in.

### DESCRIPTION OF RELATED ART

There is a trend within the field of portable communication devices, and especially within the field of cellular phones to have the antenna built-in, in the device itself. Probably, future portable communication devices will be small in size and light in weight. Typically, in such devices, built-in antennas will even be required. Today, existing portable communication devices such as cellular phones provided with built-in antennas normally have so-called “microstrostrip” antennas or so-called “planar inverted-F” antennas (PIFAs).

Microstrip antennas have low profile, are small in size and light in weight, but do not always provide use of more than one band, i. e. do not offer so-called “multi-band” capability. In the case of a micro-strip antenna multi-band capability could be provided as multiple strip line parts which resonant at different frequencies, thus, as a result an antenna providing multi-band possibility. An example of this technique, could be found in U.S. Pat. No. 6,166,694. In this document a printed twin-spiral dual band antenna is disclosed.

PIFAs have already been used in mobile phones and is one of the most promising designs. See for instance K. Qassim, “Inverted F-antenna for portable handsets”, IEEE Colloqlum on Microwave Filters and Antennas for Personal Communication Systems, pp. 3/1-3/6, February 1994, London, UK.

Also meandering inverted F-antennas have been described, see for instance WO-A1-96/27 219, whereby antenna size can be reduced compared to conventional PIFAs.

However, as the portable communication devices become smaller, at the same time multiple antennas for instance for cellular, wireless local area networks (LANs), GPS applications etc will be required, whereby conventional antennas will still not be able to provide sufficient multi-band capability, and in particular not sufficient bandwidth and/or will be too large to fit small chassis of future portable communication devices.

There is therefore a need for an antenna arrangement for a portable communication device, which provides sufficient band width, in particular such an antenna arrangement which provides broad-band capability despite small volume.

### SUMMARY OF THE INVENTION

The present invention is directed towards solving the problem of providing an antenna arrangement, in particular a built-in antenna arrangement, that provides broad-band capability combined with light weight and/or small size.

An object of the present invention is also to provide an antenna arrangement solving the problem(s) stated above. Another object of the invention is to provide a portable communication device comprising such an antenna arrangement.

According to a first aspect of the present invention, this is achieved by an antenna arrangement comprising:

a first antenna patch to be connected to a first feeding potential, and

a second antenna patch to be connected to a second feeding potential, said antenna patches being adapted to comprise capacitance feeding being frequency dependent.

In this way a variable capacitance is provided which is frequency dependent. This provides much more bandwidth, typically twice as much when compared to a conventional PIFA having the same antenna volume.

A second aspect of the present invention is directed towards an antenna arrangement including the features of the first aspect, wherein the patches are separated by a gap comprising dielectric or forming material. Since the antenna arrangement looks like dual L:s, in the following, the antenna arrangement, according to various embodiments of the present invention, will also be referred to as a “PDLA” (Planar Dual L Antenna). Preferably, the dielectric material has low dielectric constant.

A third aspect of the present invention is directed towards an antenna arrangement including the features of the first or second aspect, wherein the length of the gap is between 0.1 to 0.3% of a wavelength coming to/from a source.

A fourth aspect of the present invention is directed towards an antenna arrangement including the features of the first, second or third aspect, wherein the second feeding potential is ground.

A fifth aspect of the present invention is directed towards an antenna arrangement including the features of the first, second, third or fourth aspect, wherein the patches have a length approximately equal to a quarter of a wavelength at the operating frequency band.

A sixth aspect of the present invention is directed towards an antenna arrangement including the features of the first, second, third, fourth, or fifth aspect, wherein the connection between the first feeding potential, provided by a radio circuit (source) and first patch is screened.

A seven aspect of the present invention is directed towards an antenna arrangement including the features of the first, second, third, fourth, fifth or sixth aspect, wherein the radio circuit is connected to the first patch at an edge thereof.

Another object of the present invention is directed towards providing a portable communication device including an antenna arrangement.

According to an eight aspect of the present invention, this object is achieved by a portable communication device, said device comprising a chassis having a microphone, a speaker opening, and a keypad, wherein the device further comprises an antenna arrangement, said antenna arrangement comprising:

a first antenna patch to be connected to a first feeding potential, and

a second antenna patch to be connected to a second feeding potential, said antenna patches being adapted to comprise capacitance feeding being frequency dependent.

The invention has the following advantages: The antenna arrangement has broad-band capability, whereby much wider bandwidth can be achieved by using the same volume as prior art antennas. It is cheap and easy to implement in a portable communication device. In addition, the PCB space requirement for the built-in antenna arrangement is minimised due to its small size.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 schematically shows a perspective view of antenna arrangement according to a first embodiment of the invention.

FIG. 2 shows a cross-sectional view of the antenna element illustrated in FIG. 1, said view taken along a line A-A in FIG. 1.

FIG. 3 shows an equivalent circuit of the antenna arrangement in FIGS. 1-2.

FIG. 4 shows a simulation result in the form of a frequency curve obtained by using a simulation tool.

FIG. 5 illustrates an embodiment of a portable communication device in which the antenna arrangement according to the present invention may be implemented.

FIG. 6 illustrates a return loss and Smith chart of the antenna arrangement according to one embodiment of the invention.

### DETAILED DESCRIPTION OF EMBODIMENTS

As required, detailed embodiments of the present invention are disclosed herein; however, it is to be understood that the disclosed embodiments are merely examples of the invention that may be further embodied in various and alternative forms other than described below. The drawings are not necessarily to scale, and some elements may be exaggerated or minimized to show details of particular components or features. Therefore, specific structural and functional details disclosed herein are not to be interpreted as limiting in any sense, but merely as a basis for the claims and as a representative basis for enabling one skilled in the art to variously put the present invention into practice.

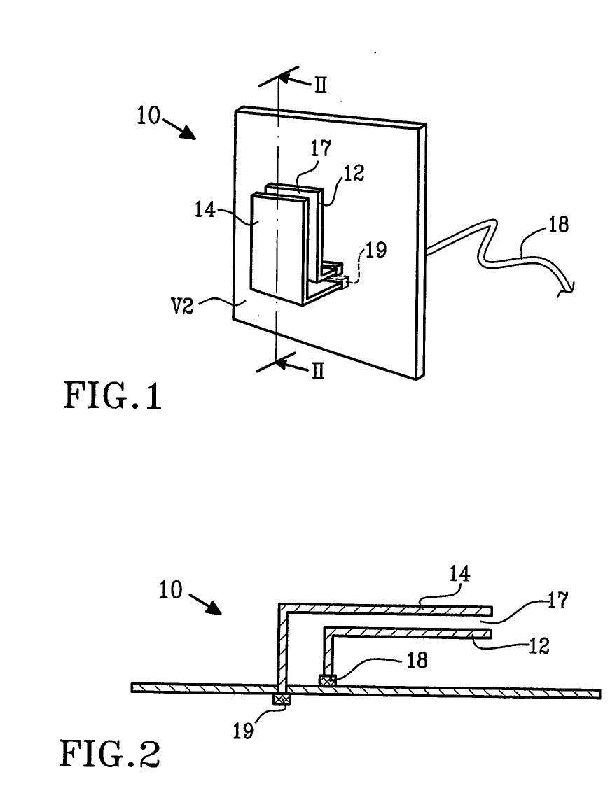

FIG. 1 schematically shows a perspective view of the antenna arrangement according to a first embodiment of the invention. The antenna arrangement 10 includes a first antenna patch 12 herein in the form of a conducting layer, to be connected to a first feeding potential V₁, and a second antenna patch 14, herein in the form of a conducting layer, to be connected to a second feeding V₂ potential, in this particular embodiment ground potential. The second feeding potential V₂ is typically ground, but can be any suitable potential including negative potential.

The antenna patches can be made of any suitable material, such as metal, polymer material or the like.

Now is referred to FIG. 2, which is a cross-sectional view of FIG. 1. The first and second patches 12, 14 are separated by a gap 17 comprising dielectric or forming material, thereby providing a variable capacitance being frequency dependent, depending on an operating frequency of the antenna arrangement. Preferably, the patches 12, 14 are in the form of L-shaped conducting layers stacked onto each other in a capacitor like fashion. The short between the second patch 14 and ground can be formed, for instance by threading conducting fabric through a slot 19. The arrangement of the antenna arrangement 10 in a portable communication device will be further described below; however, design parameters such as sufficient distance from a chassis of the device (not shown) and other parameters obvious for a person skilled in the art to design, will not be described.

Herein, the term “gap” is meant a space where no conducting elements are placed. Different dieletric or forming (electret) material can therefore be placed here. Materials to be employed as dielectric materials in the gap should preferably have low dieletric constants (such materials are dependent on the frequency at “high” frequencies, but normally not at “low” frequencies). Normally, in application within the field of the present invention, frequencies are high. Particular examples of materials are for instance: polytetrafluorethylene (PTFE) or low-density polyethylene (LDPE).

An insulated conductor 18, connecting to a radio circuit or other source (not shown) is connected to the first patch 12. The conductor 18 can for instance be a conventional coaxial cable, whereby for instance a centre conductor of the same is connected to the first patch 12, typically at an edge of the first patch 12, for instance by soldering or other suitable conventional fastening method.

The patches can have different area. For instance, by controlling the length (or the width) of the patches, the antenna arrangement can also be capable of being tuned to different frequencies, for instance to be able also to operate in multiple frequency bands. For example, a first band may be a GSM band and the second band a DCS band. Of course, other combinations of frequency bands may be implemented without departing from the invention. Examples are: GSM+PCS, GSM+WCDMA etc.

In a preferred embodiment the patches has a length approximately equal to, or approaching a quarter wavelength at the operating frequency band (e.g. around 450 MHz for a cellular phone). It can also be equal to the full wavelength.

The physical form of the patches can be any suitable, for instance planar layers, curved surfaces etc provided that they can be arranged in a capacitor-like fashion.

Typically, an overall thickness of the antenna arrangement according to the invention is below 15 mm. Tuning of the antenna arrangement can be accomplished for instance by a matching bridge (not shown).

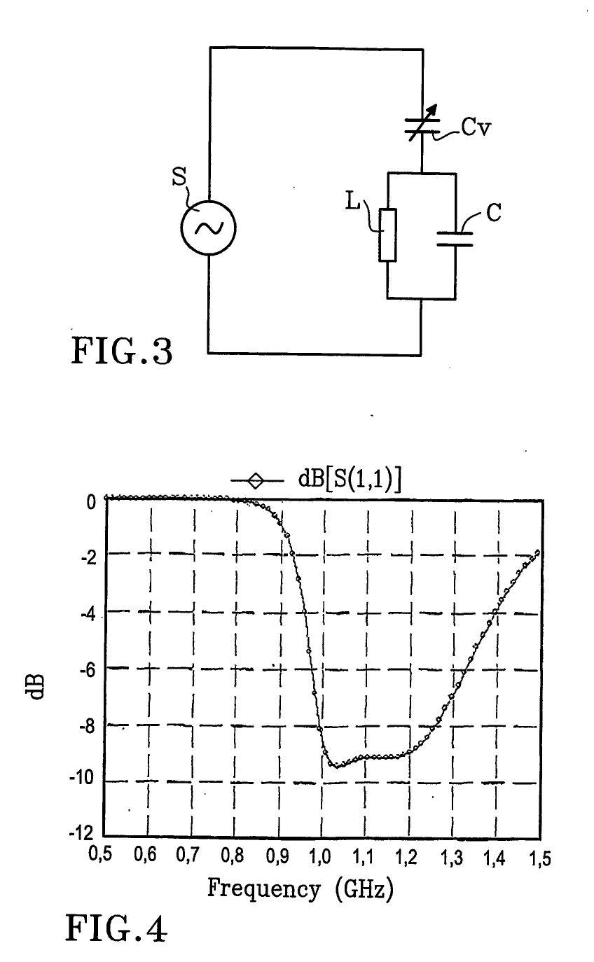

Now is referred to FIG. 3, which shows an equivalent circuit of the antenna arrangement. The antenna arrangement can be described by means of an equivalent circuit too, wherein an inductance L and a capacitor C connected in parallel are connected in series to a variable capacitor Cv having a variable capacitance (illustrated by an inclined arrow), which is frequency dependent due to the gap between the patches. Conventional PIFAs has fixed L and C, i. e. no variable capacitance Cv, whereby the bandwidth is limited when the antenna volume is small.

Typically, the gap is dimensioned such that its length and impedance allow the antenna arrangement to be fed with an intended radio frequency bandwidth to stay within limits for broad-band performance and the antenna arrangement to work well. Radiation characteristics, drive point impedance and simple construction are parameters that typically have to be considered. However, since they are well-known for a person skilled in the art to design, they will not be further discussed herein. Preferably, the gap is about 0.1 to 0.3 percent of the wavelength.

As described above, the resonant frequencies f0 and bandwidth of the built-in antenna arrangement according to the present invention are dependent upon thickness of the dielectric material, but also the type of dielectric material (i. e. the dielectric constant) will influence. The resonant frequencies could be described by a well-known general formula (I).
f0=½πLC (I)

By designing the patches smartly, broad band characteristics could be further improved. For instance a loading resistor could be provided to further enhance bandwidth.

Because of the size of the antenna arrangement of the present invention, the antenna is easily driven in many frequency bands, for instance GSM/900/1800, PCS 1900, UMTS bands and even GPS bands. The different frequency bands are easily provided by the radio circuits including components such as tuning filter or a tuning network in order to comply with the different frequency bands.

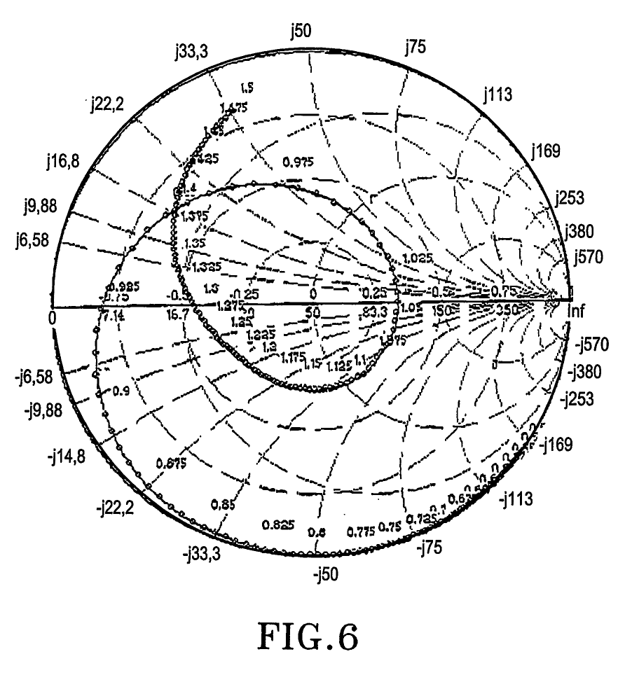

In order to illustrate the effectiveness of the present invention, FIG. 4 set forth results of simulations for exemplary antenna arrangements. FIG. 4 shows that bandwidth increases by 30% compared to a conventional PIFA. The PDLA introduces a Cv component as illustrated in FIG. 3 that allows the PDLA to have near 50 ohms in a broad-band. This is further shown in FIG. 6, in which a circle around a centre of 50 ohms is shown. In FIG. 6 it is shown the impedance of the antenna arrangement for a large frequency range. Since FIG. 6 is a conventional Smith chart it will not be further described herein.

The present invention has many advantages. The frequency dependent capacitance feeding, realised by two patches coupled to ache other, provides two resonances adjacent to each other. In this way the bandwidth is doubled compared to a conventional PIFA. The antenna arrangement provides better wideband performance because of the capacitive feeding compared to conventional PIFAs.

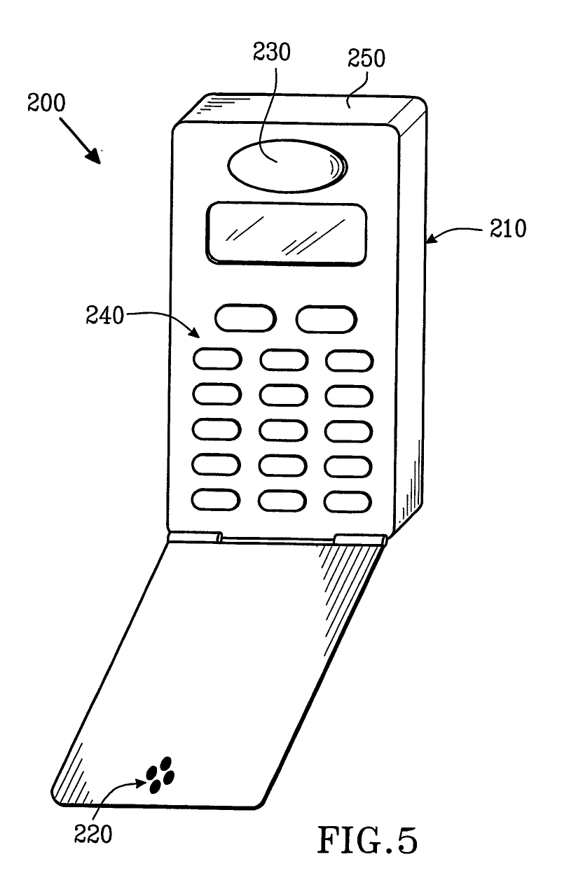

In FIG. 5, a portable communication device according to the invention will now be described in relation to a mobile phone, which is a preferred embodiment of the invention. It can be other types of electronic communication devices though, like a cordless phone, a communication module, a PDA or any other type of portable device communicating with radio waves. Most likely, there will be a number of varying portable communication devices in the future when the 3^{rd} generation cellular systems are implemented. Therefore, preferably, the portable communication device according to the present invention, provides adequate gain and bandwidth in all existing present and future frequency bands, typically within a range of 300-3000 MHz.

The portable communication device, herein a mobile phone, illustrated in FIG. 5 comprises a built-in antenna arrangement according to the present invention. The mobile phone 200 includes a chassis 210 having a microphone opening 220 and speaker opening 230 located approximately next to the position of the mouth and ear, respectively of a user. A keypad 240 allows the user to interact with the communication device, e. g. by inputting a telephone number to be dialled. The mobile phone 200 also includes a built-in antenna 250, the details of which have been described above.

The foregoing has described the principles, preferred embodiments and modes of operation of the present invention. However, the invention should not be construed as being limited to the particular embodiments discussed above. Thus, the above-described embodiments should be regarded as illustrative rather than restrictive, and it should be appreciated that variations may be made in those embodiments by workers skilled in the art without departing from the scope of the present invention as defined by the following claims.

1. An antenna arrangement for a portable communication device, comprising:
a first antenna patch configured to be-connected to a first feeding potential (V1), and a second antenna patch configured to be connected to a second feeding potential (V2), said antenna patches comprising a variable capacitance feeding, wherein the first and second patches are separated by a gap and have lengths approximately equal to each other.

2. An antenna arrangement according to claim 1, wherein the gap comprises dielectric or forming material.

3. An antenna arrangement according to claim 2, wherein the dielectric material has a low dielectric constant.

4. An antenna arrangement according to claim 1, wherein a length of the gap is between 0.1 to about 0.3% of a wavelength coming from/to a source.

5. An antenna arrangement according to claim 1, wherein the second feeding potential (V2) is ground potential.

6. An antenna arrangement according to claim 1, wherein the antenna patches have lengths approaching a quarter wavelength at an operating frequency band.

7. An antenna arrangement according to claim 1, wherein the connection between the first feeding potential (V1) and the first antenna patch is screened.

8. An antenna arrangement according to claim 1 further comprising a radio circuit that is configured to connect the first antenna patch at an edge thereof to the first feeding potential (V1).

9. A portable communication device, comprising:
a chassis having a microphone;
a speaker opening; and
a keypad; and
an antenna arrangement comprising a first antenna patch configured to be connected to a first feeding potential (V1), and a second antenna patch configured to be connected to a second feeding potential (V2), said antenna patches comprising a variable capacitance feeding, wherein the first and second patches are separated by a gap and have lengths approximately equal to each other.
